(19) United States
(12) Patent Application Publication
(10) Pub. No.: US 2008/0290855 A1
(43) Pub. Date: Nov. 27, 2008

(54) Battery Powered Intelligent Variable Power Supply/Battery Charger

(75) Inventor: David A. Fishman, Lakewood, NJ (US)

Correspondence Address: FOX ROTHSCHILD LLP, P O BOX 592, 112 NASSAU STREET, PRINCETON, NJ, 08542-0592, US

(73) Assignee: CHARGE 2 GO, INC., Lakewood, NJ (US)

(21) Appl. No.: 12/095,340

(22) PCT Filed: Nov. 29, 2006
(86) PCT No.: PCT/US06/61359

§ 371 Date: May 29, 2008

Related U.S. Application Data
(60) Provisional application No. 60/740,370, filed on Nov. 29, 2005.
(60) Provisional application No. 60/821,348, filed on Aug. 3, 2006.

(51) Int. Cl. H02J 1/00

(52) U.S. Cl. 323/318; 327/540

(57) ABSTRACT

A battery-powered power supply system is disclosed that is fully compatible with PMU ASIC and USB power architectures as well as being backwards compatible with the non-PMU power architectures. A battery-powered power supply utilizes a battery source (e.g., two AA battery cells in series), in a circuit including a switching power supply IC with a programmable variable output voltage and current limiter, along with a microcontroller. The invention also can include a flashlight or similar light source, which has utility beyond the obvious uses of a flashlight. The voltage and current supplied by the system of the present invention is controlled by the microcontroller to provide a variable voltage, variable as a function of time, if desired, during the charging operation. The flexibility afforded by a micro-controller controlled system allows the present invention to operate in different power or operational states and to adapt itself to the load demands. Furthermore, a unique power “boost” feature can be invoked by the user or be automatically invoked.

### CROSS-REFERENCE TO RELATED APPLICATIONS

This application is based on and claims priority to U.S. Provisional Application No. 60/740,370, filed Nov. 29, 2005, and U.S. Provisional Application No. 60/821,348, filed Aug. 3, 2006, the contents of which are fully incorporated herein by reference.

### BACKGROUND OF THE INVENTION

The rechargeable battery is the most common means used for powering handheld devices such as cellular phones, PDA's, MP3 players, and the like. Rechargeable batteries have many benefits, including a reduced impact on the environment and allowing a user the convenience of simply recharging the battery by coupling it to a source of power. When the rechargeable battery runs down, the user recharges the battery, usually from a wall powered battery charger.

Chargers have also been developed that provide charging capability from a disposable battery source, such as a single-cell AA battery. One such system has been marketed by the assignee herein, Charge2Go. The Charge2Go charger includes build-in charging and charging control circuitry and works well with handheld devices that do not contain built-in battery charging and charging control. However, recent advances in silicon integration have provided enabling technology whereby the power and charging control, among other features, are performed by a Power Management Unit (PMU) ASIC integrated into the handheld device. One example of a PMU is the Freescale MC13890 illustrated in FIG. 1 as PMU 100. In PMU 100, a power input 102 comprises a USB-OTG (Universal Serial Bus—On-The-Go) block, and an internal battery charger block 104 is built in to the PMU 100 and is directly connected to a Lithium battery 106. Although USB interfaces such as power input 102 are the most common interfaces used on data storage and computing devices, a growing number of handheld devices, e.g. Razr® and Blackberry®, use a mini-USB connector and the associated 5V/500 mA power interface used also with the USB-OTG standard. Known battery-powered battery chargers, such as the prior art Charge2Go solution described above, are not fully compatible with products that incorporate the now frequently-used PMU ASIC and USB power architectures.

One method for meeting the USB output requirements is to utilize a Switched-Mode Power Supply (SMPS) 202 powered by AA batteries 204, as shown in FIG. 2. This system uses a step-up switching power supply architecture to achieve a 5V/500 mA power output from a lower input voltage, for the duration of the charging process. However, this approach inadequately addresses the following problems:

Heat: Heat is a problem in two places, the power supply and the draining AA battery. The power supply heat is expressed in terms of the silicon junction temperature and is directly proportional to the power supply efficiency. The battery ambient temperature should not exceed 54° C. for an AA alkaline battery, and is related to the current drain, internal resistance and battery case thermal resistance to ambient air. Since the SMPS has fixed power-delivery values, the SMPS always delivers the same charge values, even for situations where they could be reduced. The traditional approach is to have a fixed 5V/500 mA output, which is 2.5 W, even though the USB spec allows a voltage as low as 4.35V and lower currents. Furthermore, heat is a problem when the AA battery voltage drops, requiring a greater input current to supply the constant 5V/500 mA output.

Size: The power supply size is an important factor for the customer and the solution of FIG. 2 requires a relatively large power supply because it is sized for worst case AA input voltage and current and worst case load current, resulting in the need to use a larger inductor, switch and filter capacitors.

Performance: The power supply performance is measured in terms of handheld device run-time, or percent completeness of internal battery recharge. The solution of FIG. 2 does not adequately meet this performance requirement because the power supply is sized to deliver a constant 5V/500 mA output, even though it is not strictly required. This drains the AA power source more quickly, which is less efficient for a battery and more of the battery energy is expended in heat and less is used to recharge the battery in the handheld device.

Compatibility: The battery powered power supply should be able to power and/or charge a supported device regardless of the state the device is in. The voltage and current provided should be safely within the operating range for the device being powered. The solution of FIG. 2 does not accommodate this compatibility issue very well because not all handheld devices are compatible with a USB power supply, only those with PMU's. Thus, the solution illustrated in FIG. 2 is not “backwards” compatible.

Accordingly it would be desirable to have a battery-powered battery-charging solution that is fully compatible with PMU ASIC and USB power architectures and that sufficiently addresses the heat, size, performance and backwards compatibility issues described above.

### SUMMARY OF THE INVENTION

The present invention is a battery-powered power supply system that is fully compatible with PMU ASIC and USB power architectures as well as being backwards compatible with the non-PMU power architectures. In accordance with the present invention, a battery-powered power supply utilizes a battery source (e.g., two AA battery cells in series), in a circuit including a switching power supply IC with a programmable variable output voltage and current limiter, along with a microcontroller. The invention also includes a flashlight, which has utility beyond the obvious uses. The voltage and current supplied by the system of the present invention is controlled by the microcontroller to provide a variable voltage, variable as a function of time, if desired, during the charging operation. The flexibility afforded by a micro-controller controlled system allows the present invention to operate in different power or operational states and to adapt itself to the load demands. Furthermore, a unique power “boost” feature can be invoked by the user or be automatically invoked.

The present invention has three basic operational states for the power supply. These states are referred to herein as standard, adaptive and pre-programmed states. The states are selected by the state of a sense pin input associated with the power jack. When the sense pin is shorted to ground, the power supply is programmed to a predetermined standard output (standard state). When the sense pin is left unconnected, the system will adapt itself to provide an output voltage suitable to power or charge the load (adaptive state). When a resistance is placed on the sense pin to ground, the system will operate in a predetermined way (pre-programmed state), depending on the resistance value. In addition to programming the power supply to a specific power supply voltage and current limit, the micro-controller may invoke a time limit and/or involve other features in this pre-programmed state.

Further embodiments include automatic sensing of the particular mode required for the particular battery needing to be charged; a built-in battery tester for testing the battery upon initial insertion and on an ongoing basis; and a battery-type classifier to identify the type of battery chemistry used to power the charger of the present invention.

### BRIEF DESCRIPTION OF THE DRAWINGS

FIG. 1 illustrates a Freescale MC13890 PMU;

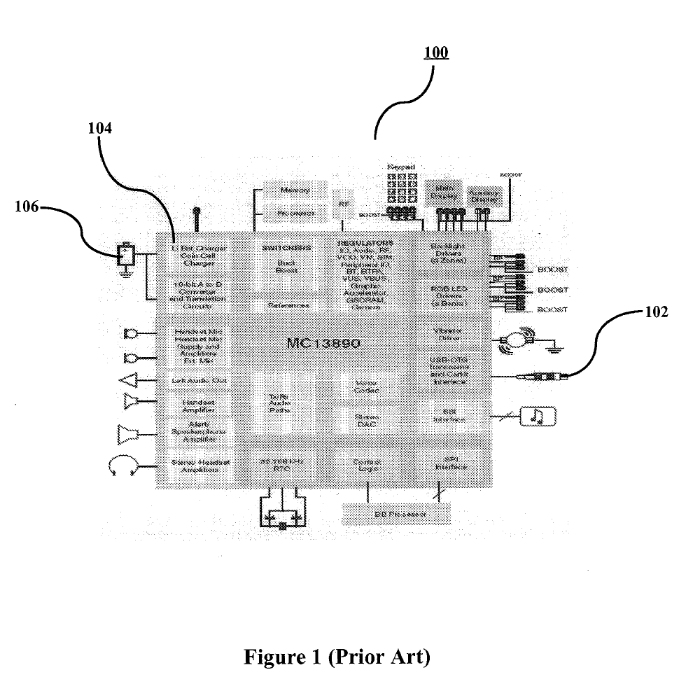

FIG. 2 illustrates a method for meeting USB output requirements utilizing a Switched-Mode Power Supply;

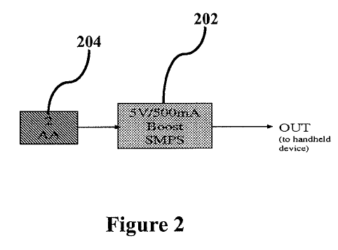

FIG. 3 illustrates the basic elements of the present invention;

FIG. 4 is a system diagram illustrating the present invention with various optional embodiments;

FIG. 5 is a flowchart illustrating steps that can be performed by the micro-controller to determine if it needs to enter the Lithium-VI mode;

FIG. 6 is a graph illustrating the voltage 402 and current 404 as it transitions from Boost-VI to Normal-VI modes;

FIG. 7 is a flowchart illustrating the operation of the present invention in the automatic timed Boost-VI mode;

FIG. 8 is a flowchart illustrating the operation of the present invention in the manual Boost-VI mode;

FIG. 9 illustrates a third embodiment for the standard state, the automatic boosting of the charging level only if the load does not draw enough current;

FIG. 10 is a flowchart illustrating an example of an algorithm that can perform the above-described process; and

FIG. 11 is a flowchart illustrating

### DETAILED DESCRIPTION OF THE INVENTION

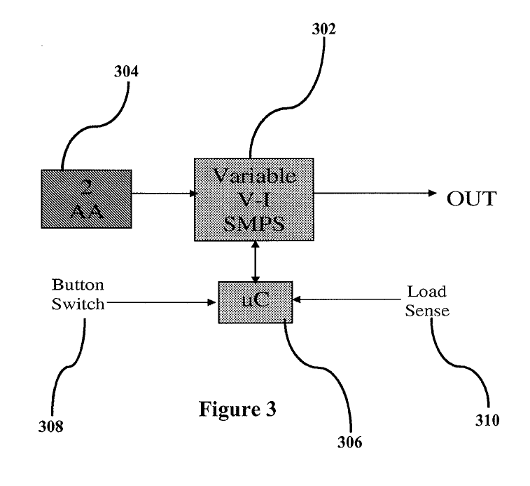

FIG. 3 illustrates the basic elements of the present invention. In the approach illustrated in FIG. 3, a variable power supply 302 receives power from AA batteries 304, and the power supplied by variable power supply 302 is controlled by microcontroller 306. The mode sense pin 310 is incorporated into the same jack that provides the power supply output power to the load. The DC state of the mode sense pin 310 determines whether the power supply will operate in standard, adaptive or pre-programmed states.

The system illustrated in FIG. 3 reduces heat and improves performance during the charging process by maximizing efficiency, and achieves compatibility with handheld devices with or without PMU/USB power architectures, by virtue of having the output voltage-current (VI) controlled by the micro-controller. The micro-controller can control the charging operation with the levels of charge delivered being variable in nature instead of being fixed at a single level. The micro-controller is configured, using known software programming techniques, to perform the various functions described in more detail below.

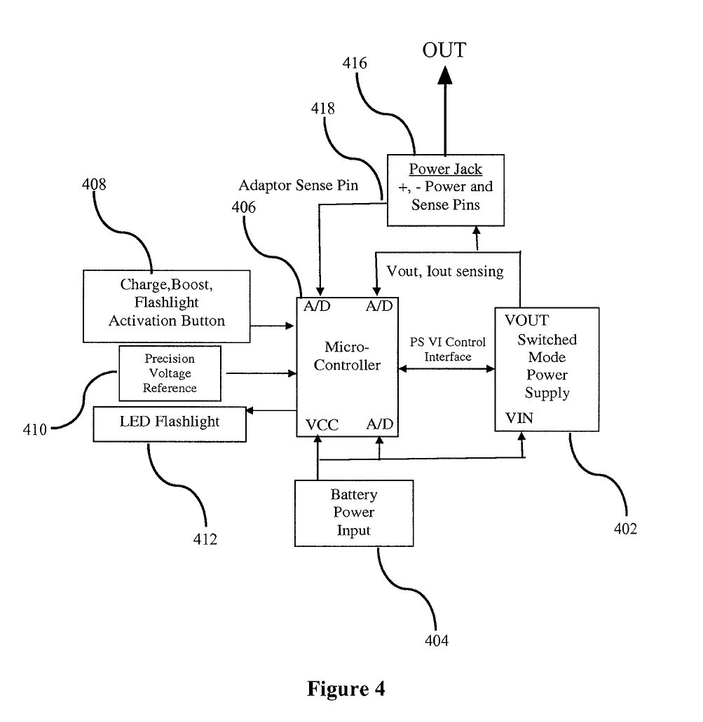

FIG. 4 is a system diagram illustrating the present invention with various optional embodiments and will now be used to describe the operation of the various operating states of the present invention. Referring to FIG. 4, a variable power supply 402 (e.g., a switched mode power supply) has an input receiving battery power from a battery power source (e.g., one or more battery cells) 404. The battery source 404 directly powers the microcontroller and its voltage level is monitored by the A/D input of micro-controller 406. Variable power supply 402 is also coupled to micro-controller 406 via a power supply VI control interface which allows the microcontroller full control over the power supply output voltage and current. The microcontroller monitors the power supply voltage and current levels using A/D circuits, as well as the mode sense 418 as will be described below.

Power jack 414 connects to the device and/or battery to be charged via output 416 and the mode sense pin 418. Adapter 420 mechanically adapts the universal power jack of the system to the custom power plug used by the load device. It also contains the mode sense resistance and/or components that the load device needs for the system to be able to power the load device.

A button switch 408 is coupled to micro-controller 406 to enable the activation of the charger, flashlight or boost charge capability. A precision voltage reference 410 coupled to micro-controller 406 to establish an A/D voltage reference in a system where the power sources are variable. Finally, LED flashlight 412 is coupled to micro-controller 406. LED flashlight 412, in addition to providing a light source, also provides a characterized load for performing battery input “state of freshness” testing under load.

Power jack 414 has a mode sense pin 418 that is coupled to a third A/D input of micro-controller 406. The purpose of mode sense pin 418 is to select the operating mode of the charger. As noted above, the present invention can operate in at least three states: standard, adaptive and pre-programmed. The previously mentioned states are invoked when the mode sense pin is grounded, left open or terminated in a resistor, respectively.

When the mode sense pin is grounded the power supply can assume one of three modes of the standard state. These are the Lithium-VI, Normal-VI and Boost-VI modes. In the Lithium-VI mode the power supply VI is programmed to 4.1V/300 mA. In the normal-VI mode, the VI is 4.5V/300 mA and in the boost mode the VI is 5V/500 mA. Other modes could be used, but for the purpose of this example, they re limited to these three.

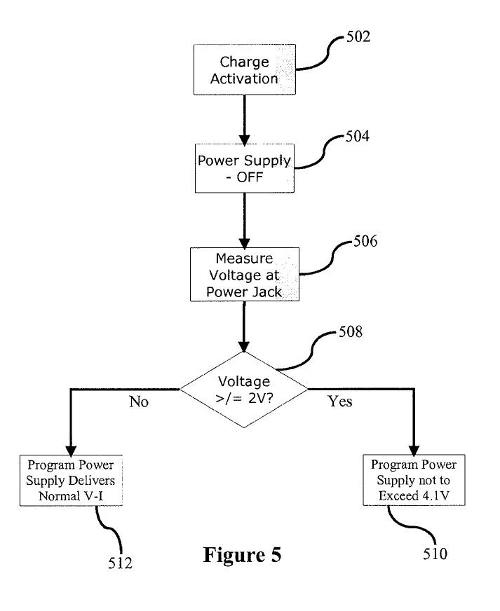

FIG. 5 is a flowchart illustrating steps that can be performed by the micro-controller to determine if it needs to enter the Lithium-VI mode. At step 502, the charge activation button is activated to begin the charging process. At step 504, the power supply that supplies charging power is turned off so that it can sense the presence of the Lithium-Ion battery at the power jack. At step 506, the voltage at the power jack is measured using known measurement techniques to determine if it is in the range of a Lithium battery, somewhere between depleted (2.3V) and fully charged (4.2V). At step 508, a determination is made as to whether or not the voltage is greater than or equal to two volts. If the voltage measured at the power jack is greater than or equal to two volts, the process proceeds to step 510, and the micro-controller configures the power supply to provide a voltage that does not exceed 4.1 volts. If, however, at step 508, it is determined that the voltage is less than 2 volts, this identifies the load device as having a PMU or another power architecture where there is a on-board charger or control electronics placed between the battery and the external charger connections. The process proceeds to step 512, where the micro-controller programs the power supply to supply Normal-VI power charging characteristics.

The two other modes in the standard state are the Normal-VI and Boost-VI modes. In one embodiment, the charger will initially begin the charge process in the Boost-VI mode and automatically throttle back to the Normal-VI mode after a timed period.

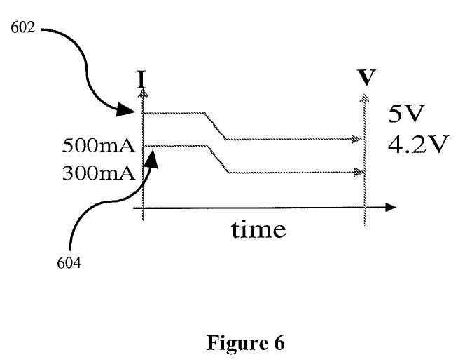

In a typical operation of the standard state, when not in the Lithium VI mode, the variable power supply 302 operates in the start-up stage, providing a full 5V and 500 mA boost charge, as the default start-up mode, and after about 2 minutes throttle back to the normal-VI mode. This is especially important since many USB powered handheld devices have extra current demands during start-up after the handheld device internal battery is fully discharged. It is understood that the actual duration of any of the charge modes can vary and two minutes is used for the purpose of example. FIG. 6 is a graph illustrating the voltage 602 and current 604 as it transitions from Boost-VI to Normal-VI modes. Voltage line 602 shows that the voltage starts out at 5V and then drops to 4.2V, while current line 604 shows that at the same time the voltage is at 5V, the current is at 500 mA, and when the voltage transistions to 4.2V the current transitions to 300 mA.

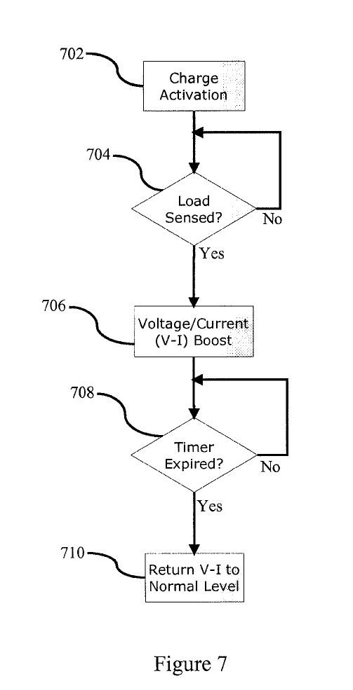

FIG. 7 is a flowchart illustrating the operation of the present invention in the automatic timed Boost-VI mode. At step 702, the charge activation button is activated to begin the charging process. At step 704, it is determined whether or not the load is drawing current. If there is no load current sensed, the process continues to sense for the existence of a load. If, at step 704, a load is detected, then at step 706 the voltage/current boost charge is applied to the load. The micro-controller begins timing the amount of time elapsed since the voltage/current boost mode was entered. At step 708, periodically the timer is checked to see if it has timed out yet. If it has not timed out, the process continues to check for the expiration of the timer. If, at step 708, it is determined that the timer has expired, then at step 710, the micro-controller controls the power supply to drop the charging power to the Normal-VI level.

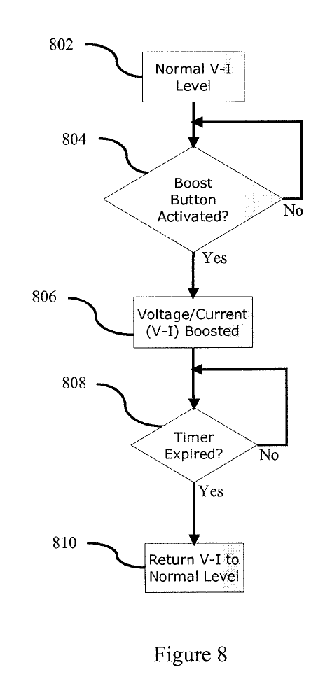

In another embodiment, the charger initiates in the Normal-VI mode and only if the user manually intervenes does the charger enter the Boost-VI mode. FIG. 8 is a flowchart illustrating the operation of the present invention in the manual Boost-VI mode. Step 802 depicts the situation where the charger is being operated at the Normal-VI charging level for the battery being charged. At some point a determination is made to boost the charging to a higher level. This might occur, for example, when the user has observed that the device connected to the charger is not responding to the charger in the accustomed way, e.g. there is no charge indication. At step 804 a determination is made as to whether or not the boost activation button has been activated. If it has not been activated, the process proceeds back to step 804 to await such activation. If, at step 804, it is determined that the boost activation button has been activated, then at step 806 the charging voltage is boosted to a desired level. A timer begins timing the amount of time that the charging is occurring at the boosted level. If, at step 808, it is determined that the time has not yet expired, the timer is continually monitored until such time as it is determined that the timer has expired. Once the timer has expired, at step 810, the charging is returned to the normal level. In an alternative embodiment, the user invoked Boost-VI mode may be permanent for the remaining charge cycle (and thus it does not time out).

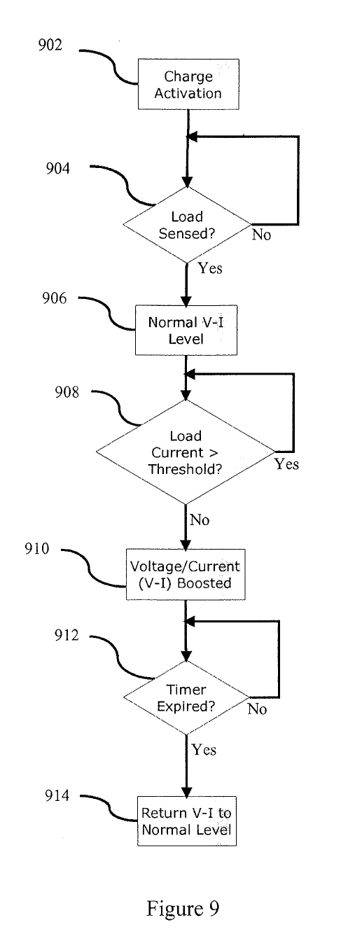

FIG. 9 illustrates a third embodiment for the standard state, the automatic boosting of the charging level only if the load does not draw enough current indicating that the voltage level at the charger output is insufficient to adequately support the charging needs of the device the charger is connected to. At step 902, the charge activation button is pressed, thereby beginning the charging process. At step 904, it is determined whether or not there is a load current sensed across the charging system. If there is no load sensed across the charging system, the system continues to monitor for the sensing of a load. If, at step 904, it is determined that a load has been sensed, then at step 906, the normal charging level is instituted.

At step 908, the value of the load current is identified. If the value of the load current is above a predetermined threshold then the process continues monitoring the load current threshold at step 908. If, however, it is determined at step 908 that the load current is beneath the load current threshold, then at step 910, the charging power is automatically boosted to the Boost-VI charging level. As with previous embodiments, at step 912, the timer is monitored and if it expires, the charging level is returned to normal at step 914. This current threshold is set low to encompass even the lightest charging loads.

The adaptive power supply VI state of the present invention is now described in detail. The adaptive state is invoked when the user presses the charging button 408 and the mode sense pin 418 on FIG. 4 is open-circuited.

The adaptive state involves configuring microcontroller 406 with an algorithm that causes the microcontroller 406 to use the output voltage and current limit capability of the variable power supply 402 to perform a set of load line measurements on the handheld device to be charged.

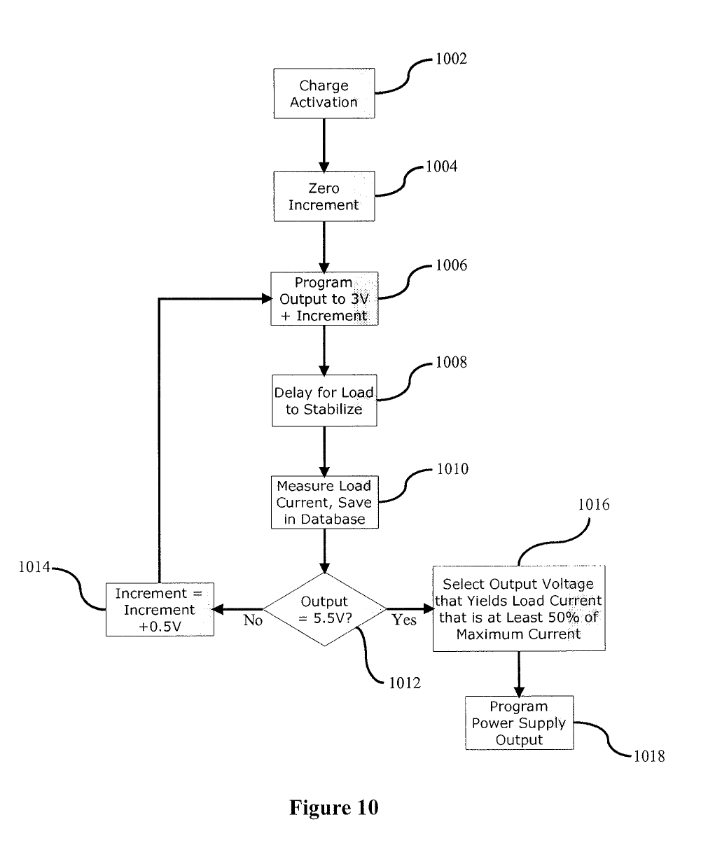

FIG. 10 is a flowchart illustrating an example of an algorithm that can perform the above-described process. This method involves the micro-controller and the variable power supply working together to learn the V-I characteristics of the load and to select a power supply output based on the information. At step 1002, the charge activation button is activated, thereby beginning the learning charging process. At step 1004, the micro-controller is initializing the variable “increment” to zero (clearing it).

At step 1006, the power supply output is incremented from 3 volts to 5.5 volts. At step 1008, a delay in of typically few seconds is instituted to allow stabilization of the load as it recognizes and adapts to the change in power supply voltage.

At step 1010, the load current is measured and saved in an array. At step 1012, a determination is made as to whether or not the output is equal to 5.5 volts (in this example). When the output voltage is equal to 5.5 volts, the process proceeds to step 1016, where the micro-controller configures the variable power supply to output a charging voltage which yields a load current that is at least 50% (arbitrarily chosen) of the maximum current. Using a value of 50% (as opposed to 100%, for example) increases the efficiency by which energy is drawn out of the battery because it done at a slower rate and thus at a reduced heat level.

If it is determined that the output voltage has not yet reached 5.5 volts, then the process proceeds to step 1014, where the micro-controller increments the variable “increment” by +0.5 volts, and then the process proceeds back to step 1006 where the power supply output voltage is reprogrammed to a voltage equal to 3V+Increment.

The third mode, the pre-programmed VI state, is now described. In the preferred embodiment, this mode is determined by the resistance value attached to the mode sense pin.

As shown in FIG. 4, a power adapter connects between the charging/power device and the battery powered equipment. The power adapter circuits, one or more specific to a particular portable device or group of devices, can place a resistance on the mode sense pin, to indicate if there should be a VI power boost or not, and for how long, or to have the power supply produce a different voltage, current or to place the system into a different mode. For example, the micro-controller may be instructed to switch an input rechargeable battery power source to the output connector so that an external charger can now recharge the power source. Likewise, the external resistor may place the flashlight 412 into a special mode such as flashing SOS or flashing to a specific beat or tempo, or flashing to the rhythm of an external audio signal applied on the mode sense pin. The resistor can affect any individual feature or combine many of these features into one mode. The limitation of the number of different modes is a function of the resolution of the A/D converter, e.g., a 10-bit A/D has a theoretical limitation of 1024 modes.

A common problem with battery powered devices is to know when to replace the batteries. The best way to determine the state of battery charge is to test them under load. Incorporated with this design is a battery test that occurs with initial battery insertion and an ongoing battery test that lights an LED when the battery level is low. The initial battery test also indicates the battery charge level, not only good or bad. The battery is tested under load by using the LED flashlight as the load. Prior to the battery test a special test of the voltage reference is performed using known software techniques to insure that the battery level measurements will be accurate. The special test is used to test the reference function without resorting to using another precision reference.

Another aspect of this design is to latch the test results so that if the battery level drops below the threshold during operation under load, and when the load is removed, the battery level rebounds, the low-battery indicator will remain active until the battery is replaced.

After the initial battery test that occurs when the batteries are inserted there is a test running in the background that monitors the battery voltage during use. There are actually three different thresholds used for tripping the low voltage warning. These thresholds correspond to different states that the product is operating in. For instance, there is an IDLE state, a FLASHLIGHT state and a CHARGING state, each with its own threshold.

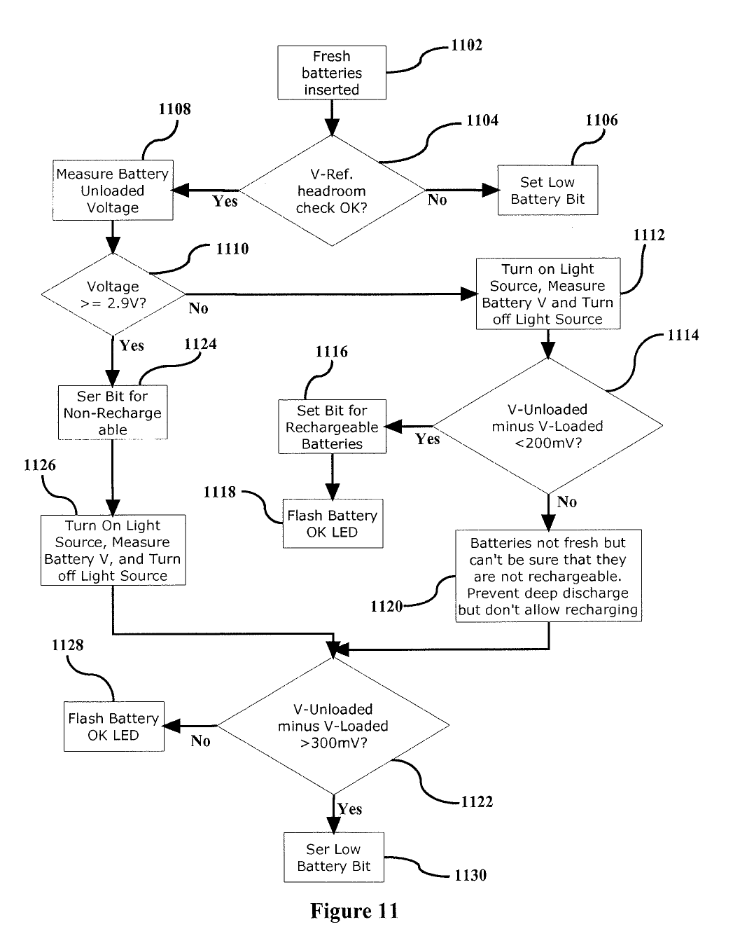

Another embodiment of the present invention incorporates a classifier to classify the battery type that powers the charger. The battery powered power supply may be powered by alkaline or rechargeable batteries. However, unless there is a mechanism to classify the battery type, the run-down operation of the power supply may diminish the cycle-life of the rechargeable batteries by subjecting them to a deep discharge. A method for performing such classification is shown in FIG. 11.

To solve this problem a series of differential voltage measurements are performed on the input batteries under loaded and unloaded conditions upon initially battery insertion. Based upon these measurements it is possible to be fairly accurate with battery classification, especially if fresh batteries are inserted. With this information the power supply software is able to cut-off battery drain earlier with rechargeable batteries so that they are not deeply discharged and lose cycle life as a result.

Referring to FIG. 11, at step 1102, fresh batteries are inserted in the power supply system of the present invention. At step 1104, a determination is made as to whether or not the voltage reference headroom is at a sufficient level. If it is not, a “low battery” bit is set at step 1106. If it is, then at step 1108, the voltage of the battery without any load is measured.

At step 1110, a determination is made as to whether or not the unloaded voltage is greater than or equal to 2.9V. If it is not, the process proceeds to step 1112, where the light source (e.g. the flashlight) is turned on, the battery voltage (now under load) is measured, and then the light source is turned off. The process then proceeds to step 1114, where the loaded voltage is subtracted from the unloaded voltage, and it is determined if that value is less than 200 mV.

If the subtracted value is not less than 200 mV, then at step 1120 it is determined that the battery is not fresh, and the battery is prevented form being deep discharged but it is not allowed to be recharged, as a safety precaution. The process then proceeds to step 1122, described below. If at step 1114 it is determined that the subtracted value is less than 200 mV, then at step 1116 a “rechargeable battery” bit is set, and at step 1118 a “battery OK” indicator is flashed to indicate same.

If at step 1110 it is determined that the unloaded battery voltage is greater than or equal to 2.9V, then at step 1124 a “non-rechargeable battery” bit is set, and then at step 1126 the light source (e.g. the flashlight) is turned on, the battery voltage (now under load) is measured, and then the light source is turned off. The process then proceeds to step 1122.

At step 1122, a determination is made as to whether or not the unloaded voltage minus the loaded voltage is greater than 300 mV. If it is, at step 1130, a “low battery” bit is set. If it is not, at step 1128 a “battery OK” indicator is flashed to indicate same.

The battery powered power supply described herein is uniquely matched to the growing number of handheld devices that utilize on-board battery chargers implemented in PMU or another ASIC. In addition, the device is backwards compatible with products that still depend on an external battery charger to charge the internal lithium battery. Special features are added, such as a battery tester and classifier, to improve the customer experience and provide consistent performance. The conceived product bundles in a LED flashlight, which is a useful adjunct in time of emergency.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed is:

1. A battery-powered power supply system, comprising:
a battery power source;
a programmable variable-output power supply having a power input coupled to receive input power from said battery power source and having a power output for outputting a power signal; and
a microprocessor, coupled to said programmable variable-output power supply, configured to control the operation of said programmable variable-output power supply to operate from among at least two states of operation.

2. The battery-powered power supply system of claim 1, wherein said microprocessor controls the operation of said programmable variable-output power supply to automatically change the characteristics of said output power signal as a function of time.

3. The battery-powered power supply system of claim 2, wherein the automatic changing of the characteristics of said output power signal as a function of time comprises operation of said power supply system in a boost mode and a normal mode, wherein in said boost mode said power supply system outputs a power signal having characteristics larger in magnitude than in said normal mode.

4. The battery-powered power supply system of claim 3, wherein said microprocessor controls the operation of said power supply system to:
operate in said boost mode upon activation of said power supply system; and
switch to said normal mode after a predetermined period of time operating in said boost mode.

5. The battery-powered power supply system of claim 3, wherein said operation of said power supply in said boost mode is triggered manually based on a manual activation by a user of said system.

6. The battery-powered power supply system of claim 5, further comprising a boost switch coupled to said microprocessor, said boost switch being activatable by a user of said system to perform said manual activation.

7. The battery-powered power supply system of claim 1, wherein a first of said at least two states comprises a standard state, whereby the microprocessor controls said power supply to output a power signal of a predetermined standard value.

8. The battery-powered power supply system of claim 7, wherein said predetermined standard value is based on the type of battery being charged.

9. The battery powered power supply system of claim 7, wherein said predetermined standard value is a predetermined normal value.

10. The battery powered power supply system of claim 7, wherein said predetermined standard value is a predetermined boost value.

11. The battery-powered power supply system of claim 7, wherein a second of said at least two states comprises an adaptive state, whereby the microprocessor is configured to:
sense the power needs of a load coupled to the output of said power supply; and
control said power supply to output a power signal suitable for the power needs of said sensed load.

12. The battery-powered power supply system of claim 11, wherein a third of said at least two states comprises a pre-programmed state, whereby the microprocessor is configured to perform one or more pre-determined functions performable by said battery-powered power supply system.

13. The battery-powered power supply system of claim 12, wherein one of said one or more pre-determined functions comprises recharging said battery power source.

14. The battery-powered power supply system of claim 12, further comprising a light source controllable by said microprocessor, wherein one of said one or more pre-determined functions comprises causing said light source to be actuated in a pre-determined manner.

15. The battery-powered power supply system of claim 1, wherein said microprocessor is configured to automatically test said battery power source upon initial insertion of said battery power source into said power supply system using said light source as a load for the test.

16. The battery-powered power supply system of claim 15, wherein said microprocessor is further configured to test said battery power source on an ongoing basis while said power supply system is operating.

17. The battery-powered power supply system of claim 15, wherein said battery power source comprises two series-connected AA batteries.

18. The battery-powered power supply system of claim 1, wherein said microprocessor is configured to identify the type of battery chemistry used by said battery power source.
